(19) United States
(12) Patent Application Publication
(10) Pub. No.: US 2017/0262443 A1
(43) Pub. Date: Sep. 14, 2017

(54) MANAGEMENT SERVER AND FILE MANAGING METHOD

(71) Applicant: Samsung Electronics Co., Ltd., Suwon-si (KR)

(72) Inventors: Jae-wook CHO, Seoul (KR); Jung-mi KIM, Seoul (KR)

(73) Assignee: Samsung Electronics Co., Ltd., Suwon-si (KR)

(21) Appl. No.: 15/234,466

(22) Filed: Aug. 11, 2016

(30) Foreign Application Priority Data
Mar. 11, 2016 (KR) 10-2016-0029376

(51) Int. Cl. G06F 17/30

(52) U.S. Cl. CPC G06F 17/3012; G06F 17/30235

(57) ABSTRACT

A management server and method thereof is provided. The management server includes a storage configured to store user account information correspondingly associated with a plurality of cloud servers, a communicator configured to receive file information of a user file stored any one or more of the plurality of cloud servers using the stored user account information correspondingly associated with the plurality of cloud servers, and a processor configured to generate a file list including the user file based on the received file information.

### CROSS-REFERENCE TO RELATED APPLICATIONS

This application claims priority from Korean Patent Application No. 10-2016-0029376, filed on Mar. 11, 2016, in the Korean Intellectual Property Office, the disclosure of which is incorporated herein by reference in its entirety.

### BACKGROUND

1. Field

Apparatuses and methods consistent with the present disclosure relate to a management server and a file managing method, and more particularly, to a management server and a file managing method, for easily managing files stored in a plurality of cloud servers.

2. Description of the Related Art

In general, an image forming apparatus refers to an apparatus for printing print data generated by a terminal apparatus such as a computer on a recording sheet. An example of the image forming apparatus may include a copier, a printer, a facsimile device, or a multifunctional peripheral (MFP) that multiply embodies these functions through one device.

Recently, along with introduction of a cloud environment, a user may store a file in various storages, and files stored in the various storages may be printed by an image forming apparatus.

Recently, the number of users who use an account of each of a plurality of cloud systems as well as an account of one cloud system has been increased. However, access to a plurality of accounts is necessary and it is difficult to manage files store in a plurality of accounts in order to manage files by a user who uses a plurality of cloud accounts.

However, conventionally, there is no method of easily managing files stored in a plurality of cloud accounts.

### SUMMARY

Exemplary embodiments of the present disclosure overcome the above disadvantages and other disadvantages not described above. Also, the present disclosure is not required to overcome the disadvantages described above, and an exemplary embodiment of the present disclosure may not overcome any of the problems described above.

The present disclosure provides a management server and a file managing method, for easily managing files stored in a plurality of cloud servers.

According to an aspect of the present disclosure, a management server connectable to a plurality of cloud servers includes a storage configured to store user account information correspondingly associated with a plurality of cloud servers, a communicator configured to receive file information of a user file stored in any one or more of the plurality of cloud servers using the stored user account information correspondingly associated with the plurality of cloud servers, and a processor configured to generate a file list including the user file based on the received file information.

The processor may control the communicator to provide the generated file list to a user terminal apparatus.

In response to search information being received from the user terminal apparatus, the processor may generate a search list corresponding to the received search information using the file list and control the communicator to transmit the generated search list to the user terminal apparatus.

In response to a file being received from the user terminal apparatus, the processor may store the received file in at least one of the plurality of cloud servers.

The processor may determine a cloud server in which the received file is to be stored among the plurality of cloud servers in consideration of at least one of a storage capacity, a storing period, a storing cost, and a storing speed of a cloud server and stores the received file in the determined cloud server.

The processor may determine a cloud server in which the received file is to be stored among the plurality of cloud servers based on at least one of use of the received file, a security degree, and file attribute and stores the received file in the determined cloud server.

In response to a print command being received from the user terminal apparatus, the processor may receive a file corresponding to the received print command to a cloud server in which the file is stored and control the communicator to transmit the received file to an image forming apparatus.

The processor may generate print data corresponding to the received file and control the communicator to transmit the generated print data to the image forming apparatus.

The processor may align a plurality of files contained in the received file information under a preset condition to generate a file list.

The processor may generate a thumbnail image of each file included in the file list and stores the thumbnail in a storage.

The processor may delete at least one of a plurality of redundant files when the same file is redundantly stored in different cloud servers.

The processor may backup the file to a different cloud server from a cloud server in which the file is stored with respect to at least one file included in the file list.

The processor may move all files stored in one cloud server to at least one other cloud server and updates the file list.

The processor may generate a plurality of file lists based on at least one of use, a security degree, and file attribute of the received file.

The file list may include at least one of a file name, file attribute, a file size, information on a cloud server in which a file is stored, and position information at a cloud server.

According to another aspect of the present disclosure, a file managing method of a cloud server includes receiving file information of a user file stored any one or more of a plurality of cloud servers using pre-stored user account information correspondingly associated with the plurality of cloud server, generating a file list including the user file based on the received file information, and transmitting the generated file list to a user terminal apparatus corresponding to the pre-stored user account information.

The method may further include, in response to search information being received from the user terminal apparatus, generating a search list corresponding to the received search information using the file list, and transmitting the generated search list to the user terminal apparatus.

The method may further include receiving a file from the user terminal apparatus, and storing the received file in at least one of the plurality of cloud servers.

The method may further include backing up the file to a different cloud server form a cloud server in which the file is stored with respect to at least one file included in the file list.

According to another aspect of the present disclosure, a computer readable recording medium having recorded thereon a program for executing a file managing method, the method including receiving file information of a user file stored in any one or more a plurality of cloud servers using pre-stored user account information correspondingly associated with the plurality of cloud server, generating a file list including the user file based on the received file information, and transmitting the generated file list to a user terminal apparatus corresponding to the pre-stored user account information.

Additional and/or other aspects and advantages of the invention will be set forth in part in the description which follows and, in part, will be obvious from the description, or may be learned by practice of the invention.

### BRIEF DESCRIPTION OF THE DRAWINGS

The above and/or other aspects of the present disclosure will be more apparent by describing certain exemplary embodiments of the present disclosure with reference to the accompanying drawings, in which:

FIG. 1 is a block diagram illustrating a cloud file management system according to an exemplary embodiment of the present disclosure;

FIG. 2 is a diagram for explanation of a file managing method according to an exemplary embodiment of the present disclosure;

FIG. 3 is a block diagram illustrating a configuration of the management server of FIG. 1;

FIG. 4 is a diagram for explanation of a method of registering a cloud account to a management server according to an exemplary embodiment of the present disclosure;

FIG. 5 is a diagram for explanation of a method of registering a cloud account to a management server according to another exemplary embodiment of the present disclosure;

FIG. 6 is a diagram for explanation of a process of simultaneously moving files according to the present exemplary embodiment;

FIG. 7 is a diagram for explanation of a print operation according to the present exemplary embodiment;

FIG. 8 is a diagram for explanation of a scan operation according to the present exemplary embodiment;

FIG. 9 is a diagram for explanation of a file management operation of a user terminal apparatus;

FIG. 10 is a diagram for explanation of a print operation of a user terminal apparatus;

FIG. 11 is a diagram for explanation of a scan operation in a user terminal apparatus;

FIG. 12 is a block diagram illustrating a simple configuration of the user terminal apparatus of FIG. 1;

FIGS. 13 to 15 are diagrams illustrating an example of a user interface window displayable on the user terminal apparatus of FIG. 1;

FIG. 16 is a flowchart for explanation of a file managing method of a management server according to an exemplary embodiment of the present disclosure; and

FIG. 17 is a flowchart for explanation of a file managing method of a user terminal apparatus according to an exemplary embodiment of the present disclosure.

### DETAILED DESCRIPTION

As the invention allows for various changes and numerous embodiments, particular embodiments will be illustrated in the drawings and described in detail in the written description. However, this is not intended to limit the present disclosure to particular modes of practice, and it is to be appreciated that all changes, equivalents, and substitutes that do not depart from the spirit and technical scope of the present disclosure are encompassed in the present disclosure. In the description of the present disclosure, certain detailed explanations of related art are omitted when it is deemed that they may unnecessarily obscure the essence of the invention.

The terms such as “first” and “second” are used herein merely to describe a variety of constituent elements, but the constituent elements are not limited by the terms. The terms are used only for the purpose of distinguishing one constituent element from another constituent element.

The terms used in the present specification are used for explaining a specific exemplary embodiment, not limiting the present inventive concept. Thus, the singular expressions in the present specification include the plural expressions unless clearly specified otherwise in context. Also, the terms such as “include” or “comprise” may be construed to denote a certain characteristic, number, step, operation, constituent element, or a combination thereof, but may not be construed to exclude the existence of or a possibility of addition of one or more other characteristics, numbers, steps, operations, constituent elements, or combinations thereof.

In exemplary embodiments of the present disclosure, the terms, such as ‘unit’ or ‘module’, etc., should be understood as a unit that processes at least one function or operation and that may be embodied in a hardware manner, a software manner, or a combination of the hardware manner and the software manner. In addition, a plurality of ‘modules’ or a plurality of ‘units’ may be integrated into at least one module to be embodied as at least one processor except for a ‘module’ or a ‘unit’ that needs to be embodied as a specific hardware.

Certain exemplary embodiments of the present disclosure will now be described in greater detail with reference to the accompanying drawings.

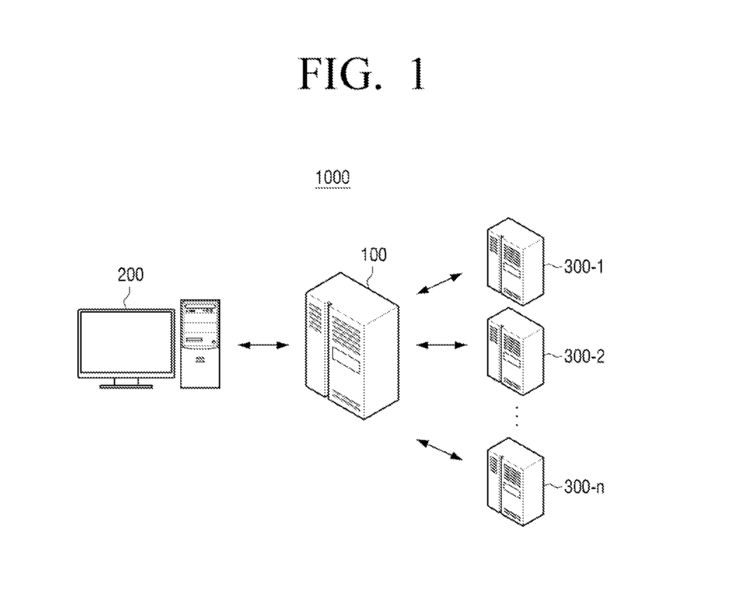

FIG. 1 is a block diagram illustrating a cloud file management system 1000 according to an exemplary embodiment of the present disclosure.

Referring to FIG. 1, the cloud file management system 1000 may include a management server 100, a user terminal apparatus 200, and a plurality of cloud servers 300-1, 300-2, through 300-n.

The management server 100 may provide a user interface (UI) environment for consolidating and displaying/managing files stored in each of the plurality of cloud servers 300-1, 300-2, through 300-n to the user terminal apparatus 200.

To this end, the management server 100 may receive user account information from the user terminal apparatus 200, collect file information on a user file stored in each of the cloud servers 300-1, 300-2, through 300-n using the received user account information, and generate a file list based on the collected file information.

In addition, the management server 100 may manage a file stored in each of the cloud servers 300-1, 300-2, through 300-n.

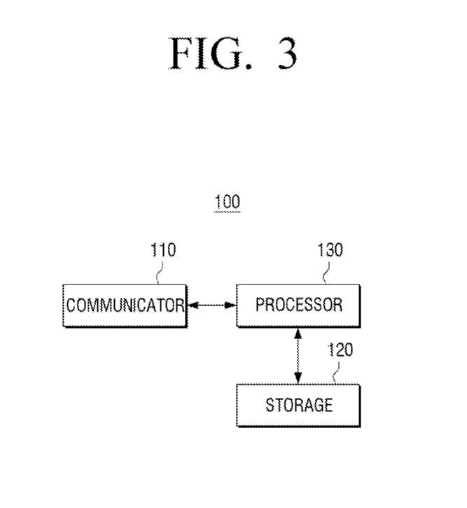

The configuration and operation of the management server 100 will be described in detail with reference to FIG. 3.

The user terminal apparatus 200 may store a file in the cloud servers 300-1, 300-2, through 300-n or search and use a file stored in the cloud servers 300-1, 300-2, through 300-n using the UI environment provided by the management server 100.

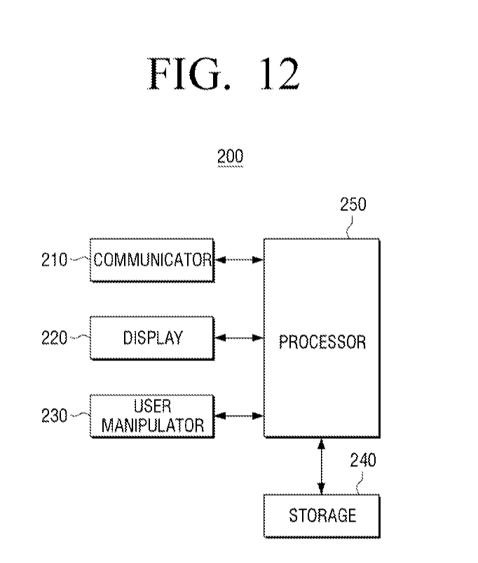

The configuration and operation of the user terminal apparatus 200 will be described in detail with reference to FIG. 12.

Each of the cloud servers 300-1, 300-2, through 300-n may store a file and transmit file information which may include the file corresponding to a user account according to a request of the management server 100 or the user terminal apparatus 200.

In addition, each of the cloud servers 300-1, 300-2, through 300-n may store a new file and may move, copy, delete, and transmit a file according to a control request of the management server 100 or the user terminal apparatus 200.

As described above, the cloud file management system 1000 according to the present exemplary embodiment may display a file stored in a plurality of cloud servers in one UI window and, thus, a user may easily manage the file stored in the plurality of cloud servers.

The cloud file management system 1000 according to the present exemplary embodiment may organize files that are redundantly stored in a plurality of cloud severs so as to reduce unnecessary resource wastes.

The cloud file management system 1000 according to the present exemplary embodiment may provide an automatic backup function of an important file and so on so as to stably manage a file.

Although FIG. 1 illustrates the case in which one user terminal apparatus is connected to the cloud file management system 1000, a user may be capable of using a plurality of electronic apparatuses. In addition, although only three cloud servers 300-1, 300-2, and 300-n are illustrated, two or four or more cloud servers may be embodiment in reality.

Although a description of file storage of the management server 100 is not given here, the management server 100 may function as a cloud server.

Although the case in which the user terminal apparatus 200 is connected to the cloud servers 300-1, 300-2, and 300-n through the management server 100 only is illustrated, a user terminal apparatus may be connected directly to the cloud servers 300-1, 300-2, and 300-n in reality.

In addition, FIG. 1 illustrates the case in which components are directly connected to each other, the components may be indirectly connected to each other through a router, a wireless sharer, or the like and may be connected in a wireless manner instead of a wired manner.

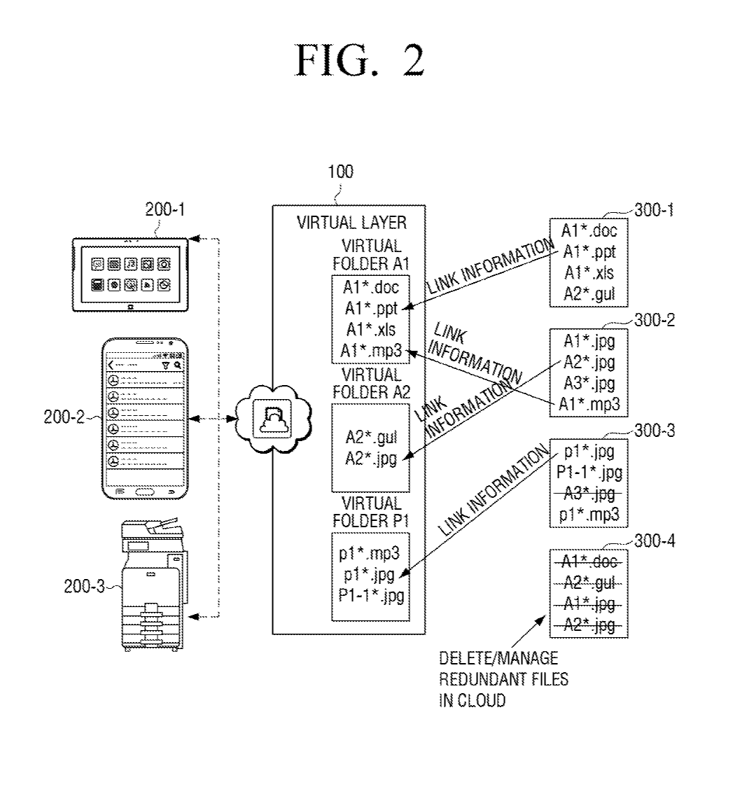

FIG. 2 is a diagram for explanation of a file managing method according to an exemplary embodiment of the present disclosure.

Referring to FIG. 2, the cloud file management system 1000 may include a plurality of user terminal apparatuses 200-1, 200-2, and 200-3, the management server 100, and a plurality of cloud servers 300-1, 300-2, 300-3, and 300-4.

First, an operation of generating file list in order to provide a UI environment for consolidating and displaying/managing files stored in each of the plurality of cloud servers 300-1, 300-2, 300-3, and 300-4 will be described.

The first user terminal apparatus 200-1 may be a tablet PC, a desktop PC, a notebook PC, or the like and may receive management account information for access to a cloud file management system (i.e., a UI environment according to the present exemplary embodiment). In addition, the first user terminal apparatus 200-1 may receive user account information such as an ID, passport information and/or other identifying information for access to each of a plurality of cloud servers, from the user.

The first user terminal apparatus 200-1 may transmit received management account information and user account information to the management server 100. In response thereto, the management server 100 may receive and store the management account information and the user account information.

In addition, the management server 100 may request each of the cloud servers 300-1, 300-2, 300-3, and 300-4 to transmit file information on the user file using user account information that is pre-stored at a preset time point (e.g., a time point when user account information is first received and a time point or preset time period for receiving a request for the file list).

In response thereto, each of the cloud servers 300-1, 300-2, 300-3, and 300-4 may transmit the file information on the user file corresponding to the received user account to the management server 100. Here, the file information may include a file name, file attribute, size information, storage position information, a final use time information, and so on, which are stored in a corresponding cloud server.

The management server 100 may generate a file list using the file information received from the cloud servers 300-1, 300-2, 300-3, and 300-4. The file list may be referred to as a virtual layer and may include each file name, file attribute, file size, and link information for actually storing a file (i.e., stored cloud server information and a position at a corresponding server).

The management server 100 may search whether there is a redundant file based on the generated file list. In detail, the management server 100 may search whether there is the same file based on a file name and size. In reality, when there are files having the same file name and size, the management server 100 may receive each of the files having the same file name and size, recognize whether the files have the same data configuration, and check whether the files are the same.

In addition, when there are redundant files, the management server 100 may delete at least one of the redundant files. In this case, the management server 100 may determine a redundant file to be deleted in advance, check whether the corresponding redundant file is a file for backup, and determine to delete a file stored in a cloud server with insufficient capacity when the redundant file is not a file for backup or determine to delete a file stored in a cloud server with high storage cost. In reality, when a redundant file is searched, the redundant file may be deleted after the user check.

For example, as illustrated in FIG. 2, the fourth cloud server 300-4 may have higher storage cost than other cloud servers. In addition, each of four files stored in the fourth cloud server 300-4 is stored in the other cloud servers 300-1, 300-2, and 300-3 and, thus, the management server 100 may delete a redundant file stored in the fourth cloud server 300-4.

In addition, during generation of the file list, the management server 100 may generate a plurality of file lists based on use, security information, and file attributes stored in each of the files stored in each of the cloud servers 300-1, 300-2, 300-3, and 300-4. For example, when illustrated files A1*.* are business files used by a user, files A2*.* are personal files, and files P1*,* are also a personal file, the business files may be grouped to one virtual folder to generate one file list, and the personal files may be grouped to other virtual folder to generate one file list.

Hereinafter, an operation of managing a file using the generated file list will be described.

When a user needs to check a business file A1*.ppt outside a company, the user may access a cloud file management system using the second user terminal apparatus 200-2 as a mobile apparatus. Here, the cloud file management system according to the present exemplary embodiment may refer to a system for managing files stored in a plurality of cloud servers in one UI.

For example, when the user drives an application for access to a cloud file system pre-installed in the second user terminal apparatus 200-2 or accesses a uniform resource locator (URL) for access to the corresponding system, the second user terminal apparatus 200-2 may transmit management account information (in detail, account information for access to a cloud file management system) to the management server 100 management account information.

The management server 100 that has received the management account information may transmit a file list corresponding to the management account information to the second user terminal apparatus 200-2. In this case, the management server 100 may check whether the second user terminal apparatus 200-2 that receives account information is a pre-registered apparatus for security and transmit the file list only when the second user terminal apparatus 200-2 is a pre-registered apparatus.

The second user terminal apparatus 200-2 may display a UI for displaying files included in the received file list in the form of a list. In this case, the user may request a file to be searched for using the displayed UI. When the file list contains many files, the user may receive a keyword and search for a required file, and the second user terminal apparatus 200-2 may search for a file corresponding to a keyword from the received file list using the received keyword or transmit the received keyword to the management server 100 and receive and display a search list from the management server 100.

Through the aforementioned procedure, a file that the user wants to process may be searched for and a processing command of the corresponding file may be input. Here, the processing command may be a preview display, an edit/execution command, a delete command, a copy command, a transfer command, a print command, or the like.

In detail, in response to a preview display command of a specific file being input from the user, the second user terminal apparatus 200-2 may request the management server 100 to transmit preview information on the specific file, receive the preview information from the management server 100, and display a received preview image (i.e., a thumbnail image).

In addition, in response to an edit/execution command of a specific file from the user, the second user terminal apparatus 200-2 may request the management server 100 to transmit the specific file, receive the specific file from the management server 100, and display (or reproduce) the received file using an application program corresponding to the corresponding file. In reality, the second user terminal apparatus 200-2 may directly request the first cloud server 300-1 for storing the corresponding file to transmit a file without passing through the management server 100 and may receive the file from the first cloud server 300-1.

In response to a specific file being edited according to the aforementioned operation, the second user terminal apparatus 200-2 may transmit the edited file to the management server 100 or the first cloud server 300-1 that stores the corresponding specific file and update an existing file.

In response to a delete command of the specific file being input from the user, the second user terminal apparatus 200-2 may request the management server 100 to delete the specific file. The management server 100 that receives the delete command may transmit the delete command to the first cloud server 300-1 that stores the corresponding file. When there is a backup file in a corresponding file, the second user terminal apparatus 200-2 may also request the cloud server 300-4 that stores the corresponding backup file to delete a file. In reality, the second user terminal apparatus 200-2 may directly transmit a delete command of the corresponding file to the first cloud server 300-1.

In response to the copy command being received, the second user terminal apparatus 200-2 may transmit the copy command of the specific file to other cloud servers, that is, the second cloud server 300-2. The management server 100 that has received the copy command may request the first cloud server 300-1 to transmit a specific file, receive the specific file from the first cloud server 300-1, and transmit the received file to the second cloud server 300-2. When data is capable of being directly transmitted and received between the first and second cloud servers 300-1 and 300-2, the management server 100 may transmit a command for transmitting a file as a copy target to the first cloud server 300-1, to the second cloud server 300-2.

In response to the transfer command being received, the second user terminal apparatus 200-2 may transmit the transfer command of a file selected by the user to the management server 100. The management server 100 that receives the transfer command may request the first cloud server 300-1 that stores a corresponding file may request to transmit the file, receive the file from the first cloud server 300-1, and transmit the received file using a method corresponding to the transfer command. For example, when the user transmits the transfer command to a specific email, the management server 100 may transmit the specific file via an email.

In addition, response to a print command being received, the second user terminal apparatus 200-2 may transmit the print command of a file selected by the user to the management server 100. The management server 100 that receives the print command may request the first cloud server 300-1 that stores the corresponding file, receive the file from the first cloud server 300-1, convert the received file into printed data, and transmit the converted print data to an image forming apparatus 200-3. When the image forming apparatus 200-3 supports direct printing for directly printing a file itself, the management server 100 may transmit the file to the image forming apparatus 200-3 through file conversion.

Hereinafter, an operation of registering a new file in a cloud server will be described.

The image forming apparatus 200-3 may perform unique functions of the image forming apparatus 200-3, that is, a printing function, a scan function, a facsimile transceiving function, an a copying function as well as the aforementioned functions of the first user terminal apparatus 200-1 and the second user terminal apparatus 200-2.

When a user scans documents using the image forming apparatus 200-3, the image forming apparatus 200-3 may scan the document and generate a scan file. In addition, the image forming apparatus 200-3 may transmit the generate scan file to the management server 100.

The management server 100 that receives the scan file may determine the cloud server 300-2 in which the scan file is to be stored, transmit the scan file to the determined cloud server 300-2, and store the scan file. In addition, a file list may be updated so as to include file information on the corresponding scan file.

In addition, this operation may be performed when a facsimile document is received. In detail, the image forming apparatus 200-3 may receive a facsimile document and generate the received facsimile data as a file with a preset file format. In this case, the image forming apparatus 200-3 may perform a print operation on the received facsimile data according to a preset option.

In addition, the image forming apparatus 200-3 may transmit the generated file to the management server 100, and the management server 100 may transmit the received file to the cloud server 300-2 and store the generated facsimile file.

Hereinafter, a file managing operation will be described.

First, the management server 100 may organize redundant files. In detail, the management server 100 may search for redundantly stored files using the generated file list and manage the retrieved redundant files so as to maintain only one file of the retrieved redundant files.

In addition, the management server 100 may generate and store a thumbnail image of each file stored in the file list. Accordingly, in response to a preview of a specific file being requested by the user terminal apparatus 200-2, a pre-stored thumbnail may be provided without requesting the first cloud server 300-1 that the corresponding file, information the file or a thumbnail image so as to perform a rapid response.

The management server 100 may generate and store a thumbnail image of each file contained in the file list.

In addition, the management server 100 may backup files contained in the file list. In detail, the management server 100 may backup all files contained in the file list or a file that satisfies a preset condition.

For example, when a storing space allocated to a user is sufficient, the management server 100 may manage files so as to store each file stored in the plurality of cloud servers 300-1, 300-2, 300-3, and 300-4 in at least two cloud servers. This operation may be similar to an operation of a redundant array of inexpensive disk (RAID) for storing a file using a plurality of storage devices in one electronic apparatus.

In addition, the management server 100 may allow only a file, which satisfies a preset condition among files stored in the plurality of cloud servers 300-1, 300-2, 300-3, and 300-4, to be backed up (that is, an operation of storing one file in a plurality of cloud servers). In reality, one cloud server among a plurality of cloud servers may function as a backup specialized server. Alternatively, each cloud server may be divided into a space for storing an original server and a backup space of a file stored in another cloud server and may be operated.

The management server 100 may manage account expiration time of each cloud server 300 and request a user for account extension or an account managing method prior to expiration time. When the user does not determine account extension or just before a preset time from account expiration time, the management server 100 may copy all files stored in the first cloud server 300-1, account of which will expire, to another cloud server 300-2.

Hereinafter, additional functions of a management server will be described.

The management server 100 may perform a file management function of a cloud server. That is, the management server 100 may perform a file server function for storing a file. Accordingly, the management server 100 may generate files stored therein and files stored in another cloud server as one file list.

The management server 100 may perform a function of an accounting server. In detail, the management server 100 may be capable of being connected to the image forming apparatus 200-3 so as to manage each image forming apparatus 200-3 and may manage print charging for each user in each image forming apparatus.

With regard to a detailed description of FIGS. 1 and 2, although the case in which the management server 100 is a separate apparatus from the image forming apparatus 200-3 has been described, the management server 100 may be embodied as a web server of the image forming apparatus 200-3.

FIG. 3 is a block diagram illustrating a configuration of the management server 100 of FIG. 1.

Referring to FIG. 3, the management server 100 may include a communicator 110, a storage 120, and a processor 130.

The communicator 110 may be formed for connection between the user terminal apparatus(es) 200 and the cloud server(s) 300 and may perform communication using a wireless communication method (e.g., GSM, UMTS, and LTE) as well as a local area network (LAN) and the Internet.

The communicator 110 may receive user account information on at least one cloud server from the user terminal apparatus 200. Here, the user account information may include an identification (ID), a password, an access address, and so on, for access to a cloud server.

In addition, the communicator 110 may transmit user information based on account information stored in each cloud server 300 and receive file information on a user file. This receiving operation may be performed in preset time units and performed when the user terminal apparatus 200 is provided a file list.

The communicator 110 may provide the generated file list to the user terminal apparatus 200. In addition, the communicator 110 may receive an alignment command (criteria for setting an order in which file(s) in the generated file list is presented) from the user terminal apparatus 200 and transmit file lists that are aligned under an alignment condition corresponding to the received alignment command to the user terminal apparatus 200 in response to the alignment command.

The communicator 110 may receive search information from the user terminal apparatus 200. In addition, the communicator 110 may transmit a search list including files with a keyword included in the received search information to the user terminal apparatus 200.

The communicator 110 may transmit generated print data to the image forming apparatus 200-3.

In addition, the communicator 110 may receive a function processing command for a specific work from the user terminal apparatus 200. Here, the function processing command may be a command such as download, copy, movement, providing of a thumbnail, and printing of a file stored in the cloud server 300. The communicator 110 may transmit the received command to the cloud server 300 corresponding to the command.

The storage 120 may store received account information. Here, the account information may include management account information (e.g., an ID and a password) for access to a cloud file management system and user account information (e.g., an ID and a password) for access to each cloud server.

The storage 120 may store the generated file list. Here, the file list may include a file name, file attribute, information on a cloud server in which a file is stored, position information at a cloud server, and so on. When a plurality of file lists is generated by the processor 130 to be described later, the storage 120 may generate a plurality of file lists.

When a plurality of users accesses the management server 100, the storage 120 may store a file list for each user and store a lookup table for management of a file list corresponding to each user.

The storage 120 may store the generated thumbnail. In detail, the storage 120 may store a thumbnail corresponding to each file contained in the file list. Here, the generated thumbnail may be stored in one folder in units of user accounts.

The storage 120 may store device information and position information of the image forming apparatus 200-3. The storage 120 may store files or print data received from the user terminal apparatus 200.

The storage 120 may store a job history of a corresponding user account.

In addition, the storage 120 may store information on an account of an image forming apparatus. Here, the information on the account of the image forming apparatus may include a physical address and account information of the image forming apparatus 200-3, and a user account for using a corresponding image forming apparatus.

In addition, when the management server 100 is used as a storage, the storage 120 may store a file of a user. According to the present embodiment, although the case in which the management server 100 stores some files of a user has been described, in reality, the management server 100 may acquire, integrate, and store files stored in a plurality of storages according to a synchronization command.

The storage 120 may store file information on a file for each user. The storage 120 may store a use history of each file. The file information may include a file name, a position, a storage, lastly corrected information, file information, and so on. In addition, the use history may include a history of upload, print, scan, facsimile transceiving, transmission, etc. of a file of at least one of a cloud server, an image forming apparatus, a user terminal apparatus, and a file server.

The storage 120 may be embodied as a removable disk including a storage medium inside or outside the management server 100, e.g., a universal serial bus (USB) memory, a file server through a network server, or the like.

The processor 130 may control each component included in the management server 100. In detail, in response to user account information on at least one cloud server being received from the user terminal apparatus 200, the processor 130 may store the received user account information in the storage 120. The processor 130 may be embodied as a central processing unit (CPU), a microprocessor, an application specific integrated circuit (ASIC), or the like and may be referred to as a control unit or a controller in that the processor 130 controls each component in the management server 100.

The processor 130 may transmit the user account information to the first cloud server 300-1 and receive file information on a user file corresponding to the corresponding user account information. In detail, when a plurality of user account information items are stored, the processor 130 may control the communicator 110 to request each cloud server 300 for file information on the user files stored in each cloud server 300. The request operation may be performed in a preset time unit and may also be performed in response to a file list being provided from the user terminal apparatus 200.

In addition, the processor 130 may generate a file list using the received file information. In detail, the processor 130 may classify file information received from each cloud server according to a preset reference to generate a file list. In this case, the processor 130 may store a print history (or a use history) of each file in the file list.

Here, the file list may include a file name, file attribute, information on a cloud server in which a file is stored, position information at a cloud server, and so on.

The processor 130 may generate a plurality of file lists based on uses, a security degree, and so on. For example, the processor 130 may generate a first file list used for user private purpose and a second file list used for company business purpose.

The processor 130 may generate a thumbnail image of each file contained in a file list. The processor 130 may store the generated thumbnail image in the storage 120. In response to a request for information on a file being received from the user terminal apparatus 200, the processor 130 may control the communicator 110 to provide a thumbnail image of a corresponding file to the user terminal apparatus 200.

The processor 130 may control the communicator 110 to provide the generated file list to the user terminal apparatus 200. In response to an alignment command being received from the user terminal apparatus 200, the processor 130 may control the communicator 110 to align files in the file list under an alignment condition corresponding to the received alignment command and transmit the aligned file list to the user terminal apparatus 200.

In response to search information being received from the user terminal apparatus 200, the processor 130 may generate a search list including a file with a keyword included in the received search information and control the communicator 110 to transmit the generated search list to the user terminal apparatus 200.

In response to a file being received from the user terminal apparatus 200 or an image forming apparatus (not shown), the processor 130 may store the received file in at least one of a plurality of cloud servers. In this case, the processor 130 may determine a cloud server in which the received file is to be stored among a plurality of cloud servers in consideration of a storage capacity of a cloud server, a storing period, a storing cost, a storing speed, and so on and store the received file in the determined cloud server. The processor 130 may determine a cloud server in which the received file is to be stored based on only one of various determination factors (a storage capacity, a storing period, a storing cost, and a storing speed), may sequentially determine a plurality of determination factors, or may apply a weight for each determination factor to determine a cloud server.

The processor 130 may determine a cloud server in which the received file is to be stored among a plurality of cloud servers based on the uses and security degree of the received file, file attribute, and so on and store the received file in the determined cloud server.

When the same file is redundantly stored, the processor 130 may automatically/manually delete one of the redundantly stored files according to user selection or preset option selection. For example, when the same is redundantly stored in different cloud servers 300-1 and 300-2, the processor 130 may delete a file stored in the first cloud server 300-1 with a high storing cost. Alternatively, when the same file is redundantly stored in the different cloud servers 300-1 and 300-2 and the two cloud servers 300-1 and 300-2 have the same storing cost, the processor 130 may maintain a file stored in the first cloud server 300-1 with a high storing speed and delete a file stored in the cloud server 300-2 with a relatively low storing speed.

The processor 130 may backup at least one file contained in the file list to a different cloud server from a cloud server in which the file is stored. For example, when a third cloud server 300-n is set as a backup server, the processor 130 may backup files stored in the first cloud server 300-1 and the second cloud server 300-2 to the third cloud server 300-n. In this case, the processor 130 may backup all files stored in each cloud server without changes or backup only a file that satisfies a preset condition (e.g., a file with a security level equal to or more than a preset level) among the all files.

The processor 130 may move all files stored in one cloud server to at least one different cloud server and update a file list. In detail, when a user account of one first cloud server 300-1 expires, the processor 130 may store all files stored in the first cloud server 300-1, an account of which will expire, in another cloud server 300-2. In this case, the processor 130 may allow a plurality of cloud servers 300-2 to classify and store all files stored in one first cloud server 300-1.

In response to a print command being received from the user terminal apparatus 200, the processor 130 may receive a corresponding file from the first cloud server 300-1 for storing a file corresponding to the received print command and control the communicator 110 to transmit the received file to an image forming apparatus (not shown). The processor 130 may convert the received file into print data recognizable by a corresponding image forming apparatus and transmit the converted print data to the image forming apparatus. The processor 130 may store a print history for each user in the storage 120 through a network.

The processor 130 may mange position information and state information on each connectable image forming apparatus 200-3. The processor 130 may search for a usable image forming apparatus on a user moving path based on path information received from the user terminal apparatus 200 and pre-stored position information.

The processor 130 may manage the user account. In detail, in response to an authentication request being received from the image forming apparatus 200-3 based on information on a user account pre-stored in the storage 120 from the image forming apparatus 200-3, the processor 130 may perform authentication based on information contained in the received authentication request and notify a corresponding image forming apparatus of the result.

As described above, according to the present exemplary embodiment, the cloud management server 100 may provide a file list used to display files stored in a plurality of cloud servers on one UI window to a user terminal apparatus and, thus, a user may easily manage the files stored in the plurality of cloud servers.

According to the present exemplary embodiment, the management server 100 may organize files that are redundantly stored in a plurality of cloud servers, thereby reducing unnecessary resource waste. In addition, according to the present exemplary embodiment, the management server 100 may provide an automatic backup function of an important file, etc. so as to stably manage a file.

Thus far, although only simple components included in a cloud server has been illustrated and described, various components may be further included in reality.

With regard to a detailed description of FIG. 3, although the case in which the management server 100 functions as both an authentication server and a storage server has been described, an authentication function and a storage function may be performed by another server in reality.

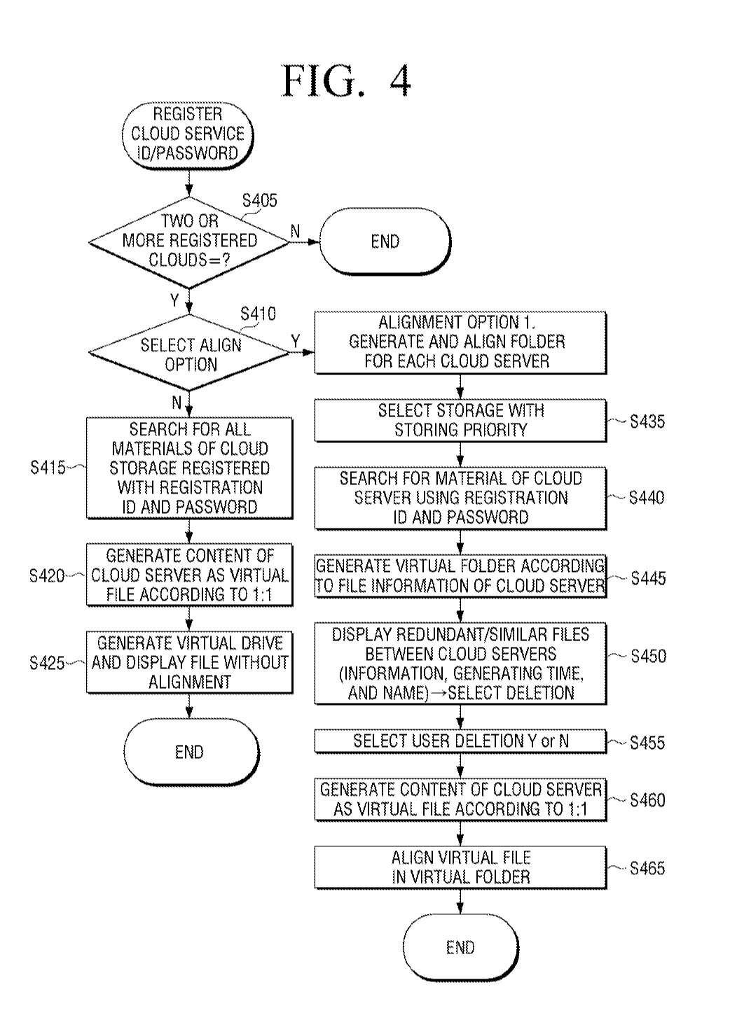

FIG. 4 is a diagram for explanation of a method of registering a cloud account to a management server according to an exemplary embodiment of the present disclosure.

Referring to FIG. 4, in response to cloud registration being requested from a user terminal apparatus, whether a plurality of cloud servers is currently registered may be determined (S405). In detail, in response to management account information being received from the user terminal apparatus 200, whether a plurality of user account information items are associated with the received management account information.

When there is one registered cloud server or there is no registered cloud server (S405-N), the method may be terminated without an additional operation. In detail, when there is one registered cloud server, a separate list may not be necessarily generated and, thus, an operation of generating a separate file list may not be performed. However, an operation of providing a UI image for registration of a user account of an additional cloud server may be performed.

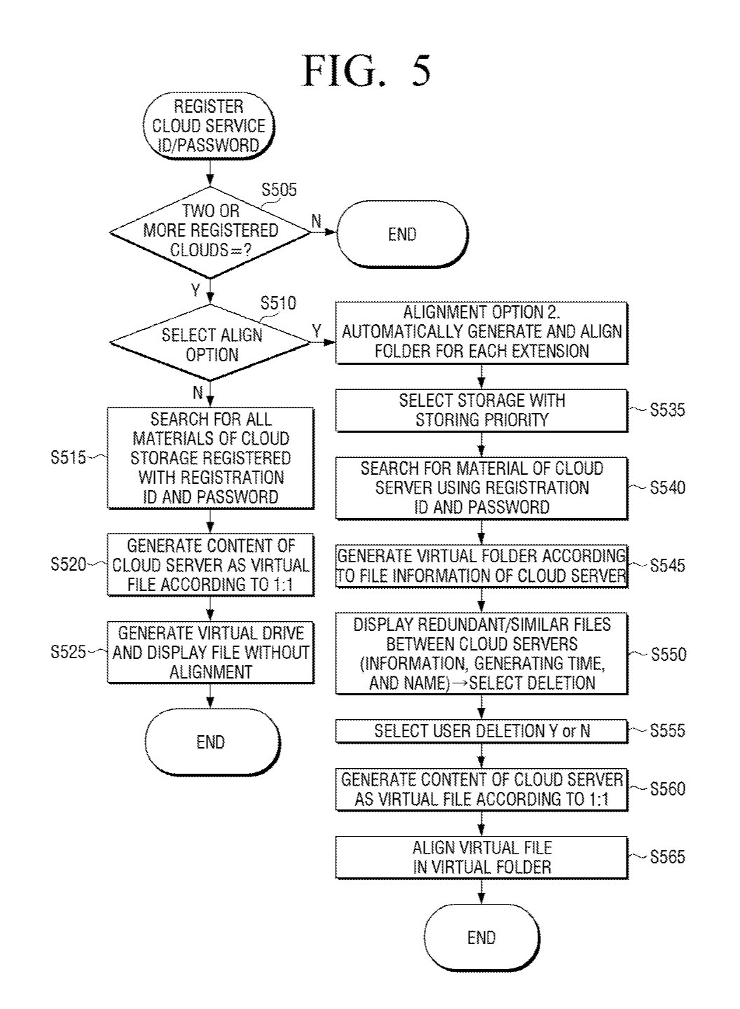

When there is a plurality of registered cloud servers (S405-Y), an alignment option may be selected (S410). Here, the alignment option may include a non-alignment option (default option), a first option for generating a folder for each cloud storage, a second option for automatically generating a folder for each extension, a third option for generating a folder for each security degree, and so on. Hereinafter, the case in which the first option is selected will be described. The case in which the second option is selected will be described below with reference to FIG. 5.

In response to a default alignment option being received by a user, the management server 100 may search for a file stored in each cloud server using pre-registered account information for each cloud (S415).

A file list (a virtual layer, or a virtual drive) in which each file and a virtual file are mapped according to 1:1 may be generated based on the retrieved file information (S420). That is, in the generated file list, all files stored in the cloud server 300 are positioned in one folder (default folder).

The generated file list may be transmitted to a user terminal apparatus so as to display the generated file list (S425).

When a user sets the first option (S430), storing priority between generated folders may be set (S435). The priority may be pre-set on a setting image, and when the priority is pre-set, preset setting data may be read and the aforementioned operation may be performed.

A file stored in each cloud server may be searched for using pre-registered account information for each cloud (S440). In detail, user account information may be transmitted to each cloud server 300 and file information of a folder, a file, etc. allocated to a user account may be received by each cloud server 300.

In addition, a plurality of folders may be generated on a virtual layer (S445). In detail, folders may be generated by as much as the number of user accounts registered by a user and a name of each generated folder may be corrected to correspond to a cloud server.

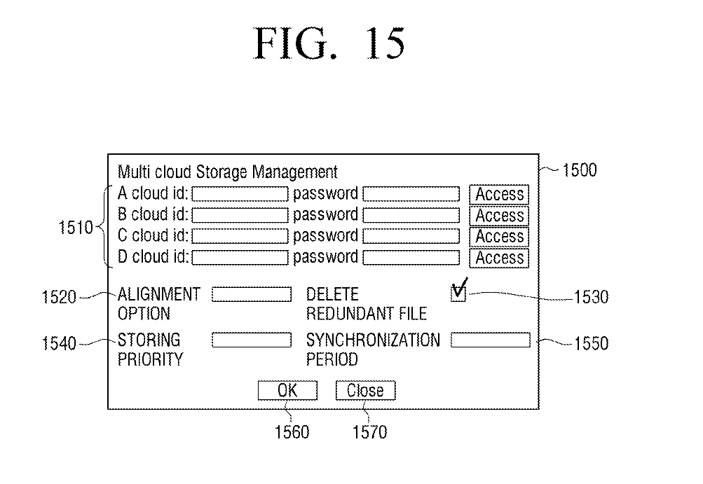

Whether there are redundant files may be searched for (S450). In detail, when a user selects a redundant file deleting option on a setting image illustrated in FIG. 15, the management server 100 may search for whether there is the same file in folders with different settings or different cloud servers 300.

In addition, a file to be deleted may be determined among the retrieved redundant files. For example, the file to be deleted may be determined in consideration of a storing cost of the cloud server 300 in which each of the redundant files is stored, storing time of a corresponding file, a use frequency of a user with respect to a cloud server in which a corresponding file is stored, etc. In addition, the determined file may be deleted (S455).

A file list (a virtual layer, or a virtual drive) in which each file and a virtual file are mapped according to 1:1 may be generated based on the retrieved file information (S460). In detail, file information items received by the first cloud server 300-1 may be stored in a first virtual folder and file information items received by the second cloud server 300-2 may be stored in a second virtual folder.

In addition, virtual files in each virtual folder may be aligned (S465).

FIG. 5 is a diagram for explanation of a method of registering a cloud account to a management server according to another exemplary embodiment of the present disclosure.

Referring to FIG. 5, in response to cloud registration being requested from a user terminal apparatus, whether a plurality of cloud servers is currently registered may be determined (S505).

When there is one registered cloud server or there is no registered cloud server (S505-N), the method may be terminated without an additional operation. However, an operation of providing a UI image for registration of a user account of an additional cloud server may be performed.

When there is a plurality of registered cloud servers (S505-Y), an alignment option may be selected (S510). Here, the alignment option may include a non-alignment option (default option), a first option for generating a folder for each cloud storage, a second option for automatically generating a folder for each extension, a third option for generating a folder for each security degree, and so on.

In response to a default alignment option being received by a user, the management server 100 may search for a file stored in each cloud server using pre-registered account information for each cloud (S515).

A file list (a virtual layer, or a virtual drive) in which each file and a virtual file are mapped according to 1:1 may be generated based on the retrieved file information (S520).

The generated file list may be transmitted to a user terminal apparatus so as to display the generated file list (S525).

When a user sets the second option (S530), storing priority between generated folders may be set (S535). The priority may be pre-set on a setting image, and when the priority is pre-set, preset setting data may be read and the aforementioned operation may be performed.

A file stored in each cloud server may be searched for using pre-registered account information for each cloud (S540). In detail, user account information may be transmitted to each cloud server 300 and file information of a folder, a file, etc. allocated to a user account may be received by each cloud server 300.

A plurality of folders corresponding to extension types may be generated on the virtual layer (S545). In addition, similar extensions may be bound as one folder. For example, as illustrated in FIG. 2, when files with extension of .doc, .ppt, .xls, .mp3, .jpg, and .gul are present in a cloud server, seven folders corresponding to seven extensions may be generated, and similar extensions may be bound as one folder to generate a document folder (.doc, .gul), a business folder (.ppt, .xls), a picture folder (.jpg), a music folder (.mp3), or the like.

Whether there are redundant files may be searched for (S550). In detail, when a user selects a redundant file deleting option on a setting image illustrated in FIG. 15, the management server 100 may search for whether there is the same file in folders with different settings or different cloud servers 300.

In addition, a file to be deleted may be determined among the retrieved redundant files. For example, the file to be deleted may be determined in consideration of a storing cost of the cloud server 300 in which each of the redundant files is stored, storing time of a corresponding file, a use frequency of a user with respect to a cloud server in which a corresponding file is stored, etc. In addition, the determined file may be deleted (S555).

A file list (a virtual layer, or a virtual drive) in which each file and a virtual file are mapped according to 1:1 may be generated based on the retrieved file information (S560). In detail, file information items received by the first cloud server 300-1 may be stored in a folder corresponding to the first cloud server 300-1 and file information items received by the second cloud server 300-2 may be stored in a folder corresponding to the second cloud server 300-2.

In addition, virtual files in each virtual folder may be aligned (S565).

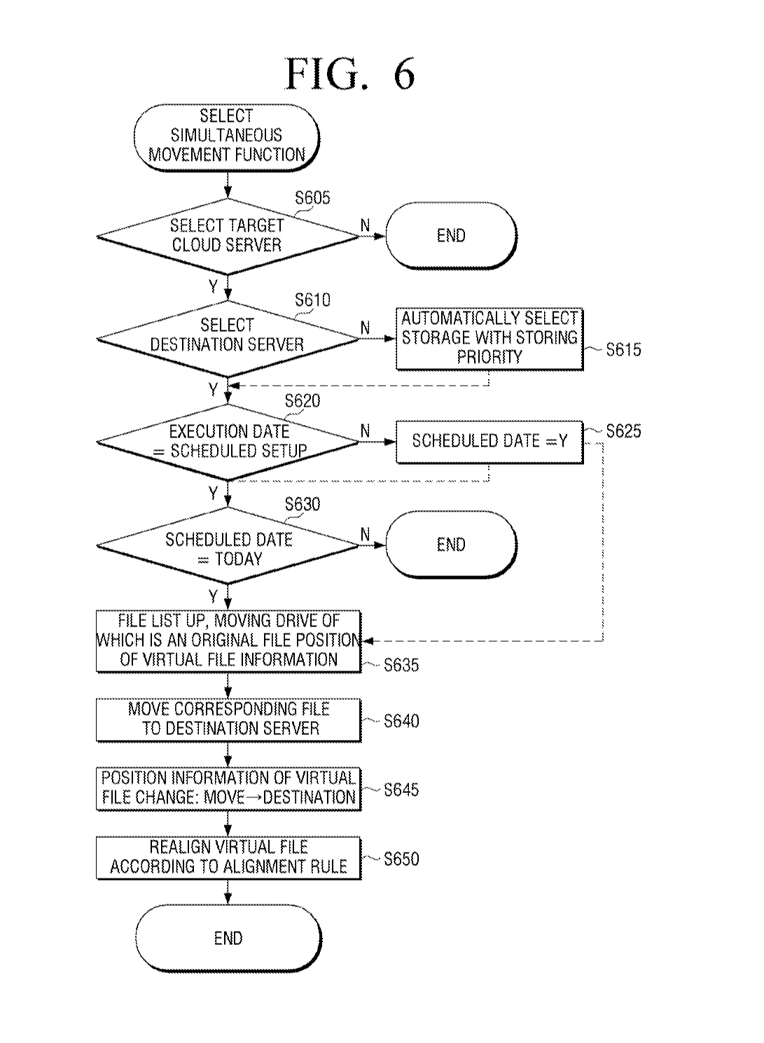

FIG. 6 is a diagram for explanation of a process of simultaneously moving files according to the present exemplary embodiment.

First, a cloud server as a movement target may be selected (S605). In detail, the selection may be directly performed by a user, and when time when a use period of a specific cloud server expires is reached, a cloud server, a period of which expires, may be automatically determined as a movement target.

A destination cloud server may be determined (S610). In detail, when the determination is not separately performed by the user (S610-N), the management server 100 may preferentially determine the corresponding cloud server 300-2 in consideration of pre-stored priority information, and a total size of files stored in the first cloud server 300-1 as a movement target when there is a cloud server for unitarily storing a corresponding total capacity. Alternatively, a cloud server with a low storing cost may be determined in consideration of a storing cost of each cloud server.

In addition, whether a schedule such as a business schedule for simultaneously moving files is set may be checked (S620). When the business schedule is not set (S620-N), a schedule for performing the corresponding simultaneous movement operation may be input (S625).

When the corresponding set schedule is immediately reached (S625) or a preset schedule is reached after time elapses (S630-Y), a file to be moved may be determined using a pre-stored file list (S635).

In addition, files determined to be moved may be moved (S640). In detail, the management server 100 may receive the file as a movement target from the first cloud server 300-1 that stores the corresponding file and transmit the file to the cloud server 300-2 as a storage target. When the first cloud server 300-1 provides a file transfer function, the management server 100 may transmit a file transfer request to the second cloud server 300-2, to the first cloud server 300-1.

When all files are moved, an actually stored address of a file as a movement target in the file list may be updated (S645).

In addition, the files in the file list may be re-aligned (S650).

According to the present exemplary embodiment, when use of one cloud server expires, the user may move a file in a cloud server, account of which will expire, to another cloud server.

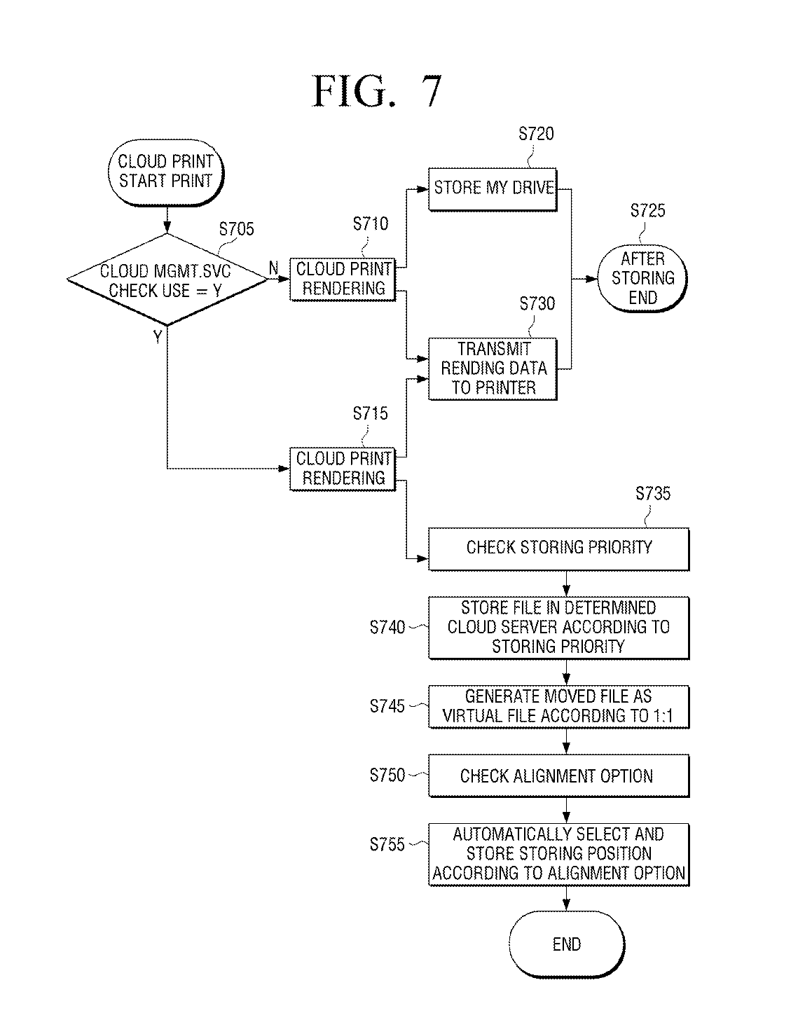

FIG. 7 is a diagram for explanation of a print operation according to the present exemplary embodiment.

Referring to FIG. 7, first, whether a print file is stored in a cloud server may be checked (S705).

When the print file is not determined to be stored in the cloud server (S705-N), print data of a file that has been selected as a target of a print command by the user may be generated (S710). In detail, when the file that has been selected as the target of the print command by the user is stored in the user terminal apparatus 200, the corresponding file may be received from the user terminal apparatus 200. When the file that has been selected as the target of the print command by the user is stored in the first cloud server 300-1, the corresponding file may be received from the first cloud server 300-1.

In addition, the received file may be converted into print data recognizable by the image forming apparatus 200-3. When the image forming apparatus 200-3 supports direct printing for printing a file without changes, this conversion operation may be omitted.

The converted print data may be stored in a print folder pre-allocated to the user (S720). In addition, simultaneously converted print data may be transmitted to the image forming apparatus 200-3 (S730).

When the print file is determined to be stored in the cloud server (S705-Y), print data of a file that has been selected as a target of a print command by the user may be generated (S715). This operation is the same as the aforementioned operation 710 and, thus, a repeated description will not be given here.

The converted print data may be transmitted to the image forming apparatus 200-3 (S730). In addition, pre-stored priority may be checked to determine a cloud server in which the converted print data is to be stored (S735). In addition, the corresponding converted print data may be transmitted to the determined cloud server (S740).

In addition, a newly transmitted file may be added to a pre-generated file list to update an existing file list (S745, S750, and S755). In detail, in consideration of an alignment option, etc. of the user, a position of the print data, which is newly added to the file list, at a virtual layer may be determined and the file list may be updated to contain information of the corresponding print data in the determined virtual position.

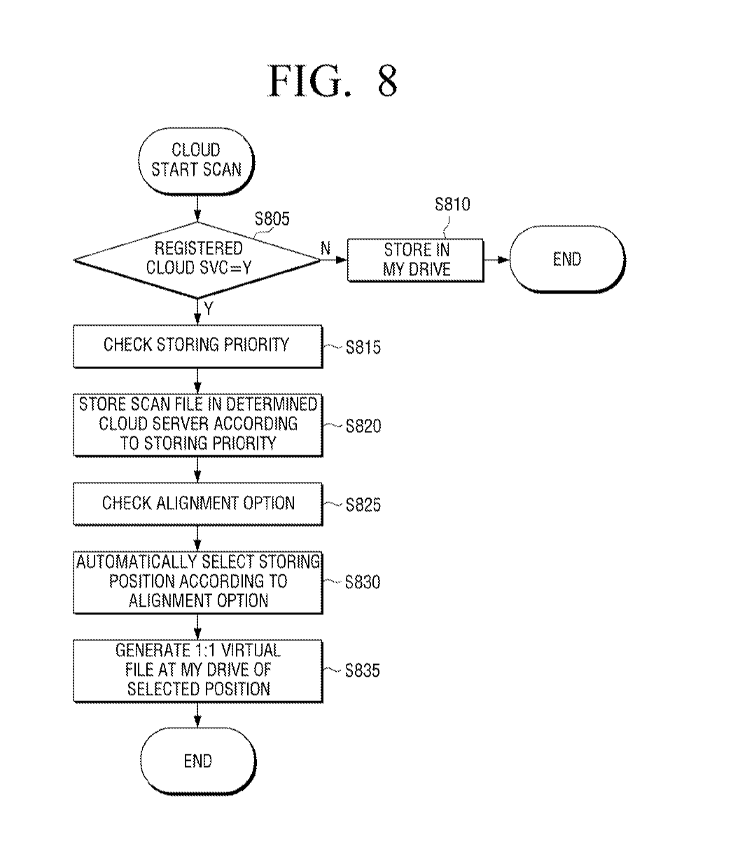

FIG. 8 is a diagram for explanation of a scan operation according to the present exemplary embodiment.

Referring to FIG. 8, in response to scan data being received from the image forming apparatus 200-3, whether the received scan file is stored in a cloud server may be checked (S805).

When the scan file is not determined to be stored in the cloud server (S805-N), the received scan file may be stored in a print folder pre-allocated to the user (S810). The print folder may be a folder in a user terminal apparatus or a storage in a printer server, but not a cloud server.

When the user determines that the scan file is to be stored in the cloud server (S805-Y), pre-stored priority may be checked to determine a cloud server in which the converted print data is to be stored (S815). In addition, the received scan data may be transmitted to the determined cloud server (S820).

In addition, a newly transmitted file may be added to a pre-generated file list to update an existing file list (S825, S830, and S835). In detail, in consideration of an alignment option, etc. of the user, a position of the print data, which is newly added to the file list, at a virtual layer may be determined and the file list may be updated to contain information of the corresponding print data in the determined virtual position.

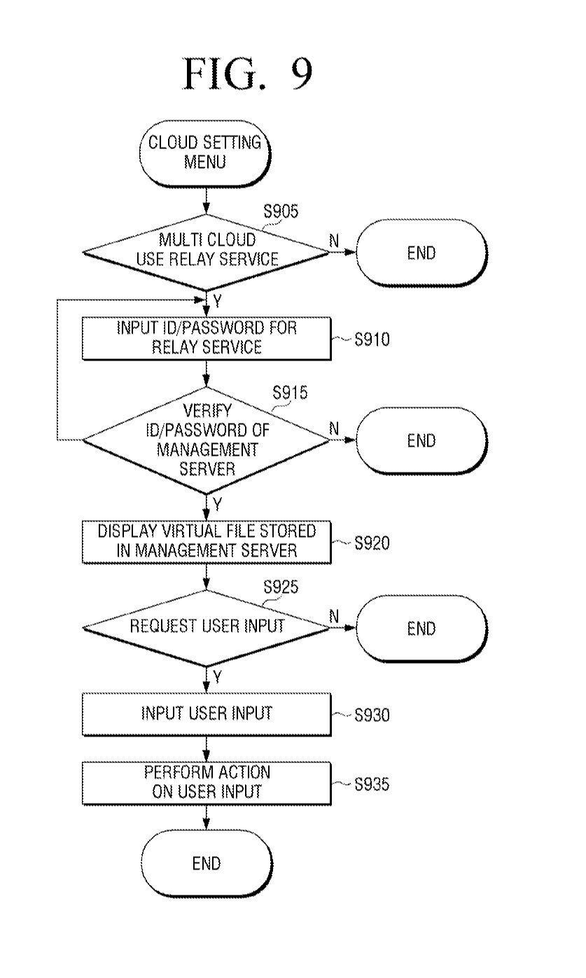

FIG. 9 is a diagram for explanation of a file management operation of a user terminal apparatus.

Referring to FIG. 9, according to the present exemplary embodiment, whether a cloud file management system (or a multi-cloud relay service) is set to be used may be checked (S905).

When the cloud file management system is set to be used (S905-Y), management account information for access to the corresponding cloud file management system may be received (S910).

The user terminal apparatus 200 that receives the account information may transmit the management account information to the management server 100.

In response to the transmission of the management account information, the management server 100 may determine whether a request corresponding to the management account information is authenticated (S915) and provide a pre-generated file list to a user terminal apparatus of an authenticated user.

The user terminal apparatus 200 that receives the file list may display the received file list (S920). In response thereto, when a user file management command of the displayed file list is received (S925-Y and 930), the received file management command may be transmitted to the management server 100 (S935).

The management server 100 that receives the file management command may perform management corresponding to the received file management command.

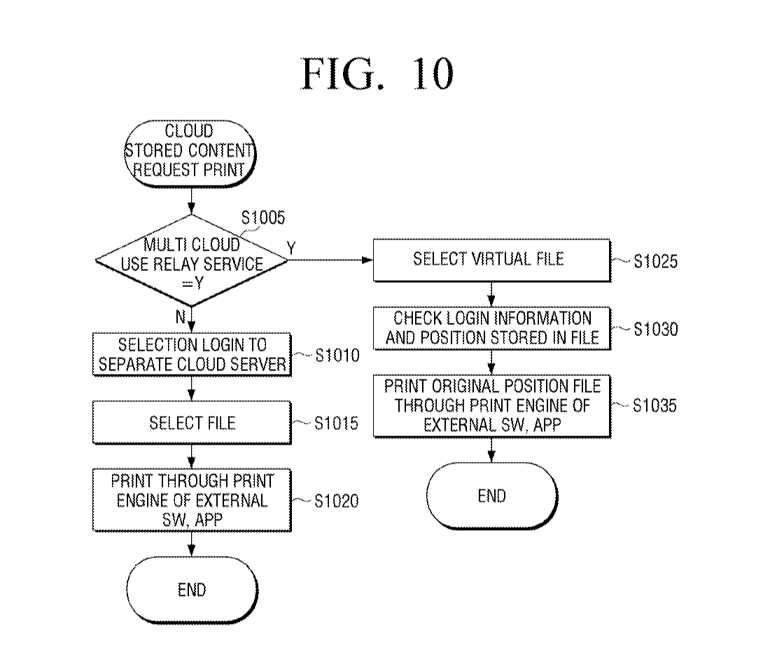

FIG. 10 is a diagram for explanation of a print operation of a user terminal apparatus.

Referring to FIG. 10, according to the present exemplary embodiment, whether a cloud file management system (or a multi-cloud relay service) is set to be used may be checked (S1005).

When the cloud file management system is not set to be used (S1005-N), a user interface (UI) for access to a separate cloud server may be displayed and user account information required to access to the corresponding cloud server may be received from the user (S1010).

In response to the user account information being received, files stored in the corresponding cloud server are displayed through a UI image provided by the corresponding cloud server, and in this case, a print command of one of the displayed files may be received from the user (S1015).

In response to a print command of a specific file being received, a print operation may be performed on the corresponding specific file using the same method as a conventional cloud printing method (S1020).

When the cloud file management system is set to be used (S1005-Y), an integrated UI image using the file list is provided by the management server 100. A file to be used in a print operation on the displayed UI image may be selected by the user (S1025).

In response to a print command of the selected by the user being received, the user terminal apparatus 200 may transmit information on the file selected by the user and a print command associated therewith to the management server 100.

In response thereto, the management server 100 may check an actual storage address of a corresponding file (S1030), receive the corresponding file from the first cloud server 300-1 in which the corresponding file is stored, and perform a print operation on the received corresponding file (S1035)

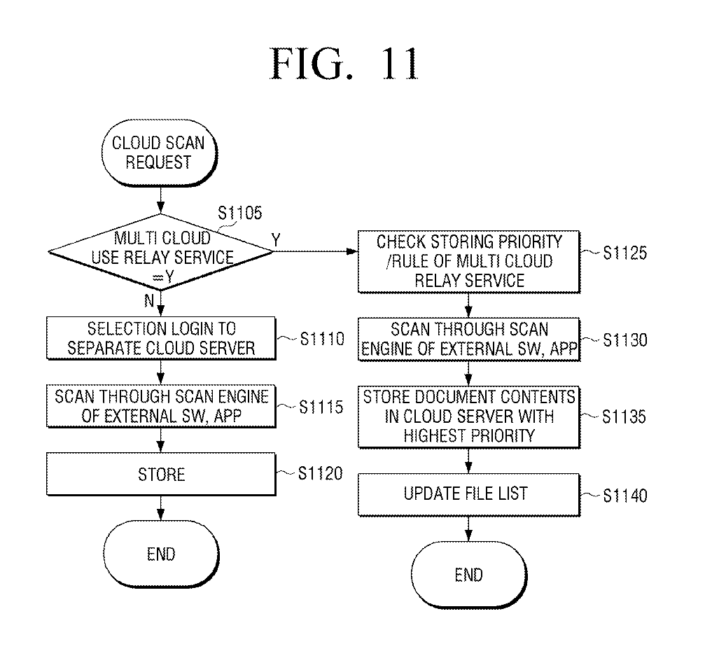

FIG. 11 is a diagram for explanation of a scan operation in a user terminal apparatus.

Referring to FIG. 11, the user terminal apparatus of FIG. 11 may be the image forming apparatus 200-3.

First, the image forming apparatus 200-3 may check whether a cloud file management system (or a multi-cloud relay service) is set to be used (S1105).

When the cloud file management system is not set to be used (S1105-N), a UI for access to a separate cloud server may be displayed and user account information required to access to the corresponding cloud server may be received from the user (S1110).

In response to a scan command being received from the user, a document may be scanned to generate scan data (S1115), the generated scan data may be transmitted to a cloud server corresponding to the user account information (S1120).

When the cloud file management system is set to be used (S1105-Y), the image forming apparatus 200-3 may notify the management server 100 of scan data to be transmitted and, thus, the management server 100 may determine the cloud server 300 in which the scan data to be received is to be stored. In detail, in consideration of preset priority information, a storing cost for each cloud server, the cloud server in which the received scan data is to be stored may be determined.

In addition, the image forming apparatus 200-3 may be notified of information on the determined first cloud server 300-1.

In addition, the image forming apparatus 200-3 may scan a document to generate scan data and transmit the generated scan data to the determined first cloud server 300-1 (S1135). In reality, the image forming apparatus 200-3 may transmit the scan data to the management server 100 and the management server 100 may transmit the scan data to the determined cloud server.

A new file is added to the first cloud server 300-1 and, thus, the management server 100 may update the file list to contain the new file (S1140).

FIG. 12 is a block diagram illustrating a simple configuration of the user terminal apparatus 200 of FIG. 1.

The user terminal apparatus 200 of FIG. 12 may be embodied as various types of apparatuses, in detail, a television (TV), a personal computer (PC), a laptop PC, a cellular phone, a tablet PC, personal digital assistants (PDA), an MP3 player, a kiosk, a digital photo frame, and so on. When the user terminal apparatus 200 is embodied as a portable type apparatus such as a cellular phone, a tablet PC, PDA, an MP3 player, and a laptop PC, the user terminal apparatus 200 may be referred to as a mobile device, when the user terminal apparatus 200 has a print function, the user terminal apparatus 200 may be referred to as an image forming apparatus, and when the user terminal apparatus 200 has a scan function, the user terminal apparatus 200 may be referred to as an image reading apparatus, but the user terminal apparatus 200 may be commonly referred to as a user terminal apparatus in the specification.

Referring to FIG. 12, the user terminal apparatus 200 may include a communicator 210, a display 220, and a processor 250. Here, the user terminal apparatus 200 may function as the first user terminal apparatus 200-1 of FIG. 2 and may also function as the second user terminal apparatus 200-2 of FIG. 2.

The communicator 210 may be formed for connection between the user terminal apparatus 200 and an external device (not shown) and may perform communication using a mobile communication (e.g., GSM, UMTS, LTE, and WiBRO) as well as a local area network (LAN) and the Internet.

The communicator 210 may receive content from another user terminal apparatus (not shown). Here, the received content may be a video image file or an image file.

The communicator 210 may transmit a file stored in the user terminal apparatus 200 to another user terminal apparatus (not shown), the management server 100, the cloud server 300, a personal file server (not shown), or the like. In addition, the communicator 210 may transmit the print data to the image forming apparatus 200-3 or the management server 100. Here, the print data may be data with a print language such as postscript (PS) and a printer control language (PCL), and when the image forming apparatus 200-3 supports direct printing, the print data may be a file itself such as PDF, XPS, BMP, and JPG.

The communicator 210 may provide management account information, user account information, etc. to the management server 100.

The communicator 210 may receive a file list corresponding to the user from the management server 100. Here, the file list may correspond to the user and include information of each file name, lastly corrected time, a size, a storage position, and a use history.

The communicator 210 may request the cloud server 300 or the management server 100 for function processing of a file. For example, the communicator 210 may request the image forming apparatus 200-3 for print processing of a file, request the cloud server 300 for print processing of a specific file, or request the management server 100 to delete a file stored in the cloud server 300.

The communicator 210 may receive a thumbnail image of a file selected by the user from the management server 100.

In addition, the communicator 210 may receive information such as a storing state of each cloud server pre-registered by the user from the management server 100.

The display 220 may display an icon of a plurality of applications pre-installed in the user terminal apparatus 200.

The display 220 may display the received file list. In detail, the display 220 may display file information contained in the received file list. For example, the display 220 may align a plurality of files according to a time sequence based on a use history of each of the files using the received file list and display the files. In this case, the display 220 may separately display a plurality of files based on the use history for each date or may separately display a plurality of files for each position of a plurality of files.

In addition, the display 220 may display a search result corresponding to the received search information. In this case, the display 220 may align and display the search result according to a preset condition. In this case, the preset condition may be an ascending order, a descending order, and so on of a file name, a file size, lastly corrected time, a recent use history, etc.

The display 220 may be a monitor such as a liquid crystal display (LCD) and may be embodied as a touch screen that simultaneously performs functions of a user manipulator 230 to be described below.

The user manipulator 230 may receive selection of any one of icons of a plurality of displayed applications. Here, the selected application may be a printer driver for control of a function of an image forming apparatus, a scan driver, a multi-cloud application corresponding to the cloud file management system according to the present exemplary embodiment, or the like. When a program is driven in response to the user selection, the user manipulator 230 may receive a file to be printed, a print option, and so on and receive a print command. The user manipulator 230 may be embodied as a plurality of buttons, a keyboard, a mouse, or the like and may be embodied as a touchscreen that may simultaneously performs the aforementioned functions of the display 220.

The user manipulator 230 may receive search information from the user. In this case, the display 220 may display a UI for reception of the aforementioned search information and the user manipulator 230 may receive the search information on the displayed UI. Here, the search information may be a search keyword for searching for a specific file by a user, for example, a file name, a storage, a keyword, time information, and so on.

The user manipulator 230 may receive a control command for performing various functions of a file stored in the user terminal apparatus 200 or a file stored in the cloud server 300, from the user. Here, the control command may be file edit, preview display of a file, file print, file deletion, copy, distribution to another user (e.g., e-mail transmission, and SNS share), or update to another storage.

When the user manipulator 230 receives a print command of a file from the user, the display 220 may display a list of connectable image forming apparatuses and receive selection of an image forming apparatus that will perform a print operation.

When the user manipulator 230 receives an edit command of a file from the user, the display 220 may display a UI image of an application program corresponding to a file.

When the user manipulator 230 receives a distribution command of a file to another user from the user, the display 220 may display another user list based on pre-stored address information on the user terminal apparatus 200 and receive selection of one of these.

A storage 240 may store various programs and data required for an operation of the user terminal apparatus 200. In detail, the storage 240 may store programs, data, and so on for configuration of various UIs constituting a user interface window.

The storage 240 may store various contents. Here, the content may be a printable document file, image file, or the like. The storage 240 may store a file list received from the management server 100.

The storage 240 may store files received from another user terminal apparatus (not shown), the management server 100, and the cloud server 300. The storage 240 may store print data of a file.

In addition, the storage 240 may store a plurality of applications. Here, at least one application may be a management application or the like for an operation according to the present disclosure.

The processor 250 may control each component in the user terminal apparatus 200. In detail, in response to a program driving command for simultaneously managing files stored in a plurality of cloud servers being received, the processor 250 may drive a file management program and control the display 220 to display a UI provided by the aforementioned program. The processor 250 may be referred to as a controller in that the processor 250 controls each component in the user terminal apparatus 200 and may be embodied as a CPU, a microprocessor, an ASIC, or the like.

In response to a function to be performed by an image forming apparatus and option information corresponding to a corresponding function being received from a user, the processor 250 may control the communicator 210 to transmit a function performing command containing a function of the selected image forming apparatus and option information.

In response to a program driving command for file management of a user being received, the processor 250 may drive the aforementioned file management program and control the display 220 to display a UI provided by the aforementioned file management program. Thus far, although a printer program and a file management program have been separately described, in reality, the printer program and the file management program may be embodied as one program.

When a file management program is driven, the processor 250 may control the communicator 210 to transmit management account information to the management server 100, and in response to a file list corresponding to the management account information being received from the management server 100, the processor 250 may control the display 220 to display the received file list.

In response to an edit command of a file being received, the processor 250 may control the communicator 210 to request the management server 100 to transmit the corresponding file, and in response to the corresponding file in response thereto, the processor 250 may drive an application program corresponding to a type of the corresponding file and control the display 220 to display a UI provided by the corresponding application program.

In response to a management control command (e.g., file deletion, copy, print, and movement) of any one of displayed files being received, the processor 250 may control the communicator 210 to transmit the corresponding management control command to the management server 100 so as to perform an operation corresponding to the corresponding management control command.

As described, the user terminal apparatus 200 according to the present exemplary embodiment may simultaneously display files stored in a plurality of cloud servers 300 and may simultaneously manage the files, thereby enhancing user convenience.

With regard to a description of FIG. 12, the case in which the user terminal apparatus 200 receives a file list from the management server 100 and displays information of a file using the received file list has been described, in reality, a side of the management server 100 may generate and transmit UI information to be displayed on the user terminal apparatus 200 and the user terminal apparatus 200 may be embodied to display the received UI information without changes.

Thus far, although only simple components constituting a user terminal apparatus have been described and illustrated, in reality, various components may be further included. For example, when a user terminal apparatus is an image forming apparatus, the user terminal apparatus may further include an image former for printing a document or a facsimile for transmitting and receiving a facsimile document, and when the user terminal apparatus is an image reading apparatus that is capable of performing a scan operation, the user terminal apparatus may further include a scanner for performing a scan operation. When the user terminal is a smart phone, the user terminal may further include a wireless communication module for communication such as LTE and 3GPP.

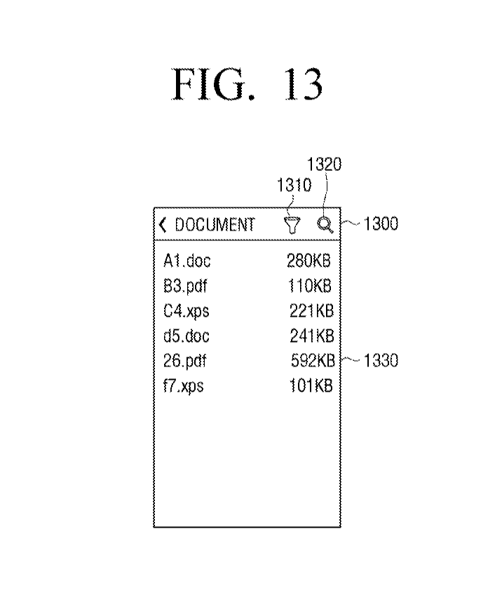

FIGS. 13 to 15 are diagrams illustrating an example of a user interface window displayable on the user terminal apparatus of FIG. 1.

In detail, FIG. 13 illustrates an example of a user interface window for displaying information on a file contained in a received file list.

Referring to FIG. 13, a user interface window 1300 may include a display region 1330 for displaying file information in the received file list, a change region 1310 of a displaying method, and a search region 1320.

The display region 1330 may be a region for displaying information of each file contained in the file list received from the management server 100. In the illustrated example, although only a file name and a file size are illustrated, in reality, a storing position of a file, a lastly corrected time of a file, and so on may also be displayed.

In addition, the type and number of displayed information items may be changed according to a type of a user terminal apparatus. For example, a mobile device with a small screen may display only a file name and a file size as illustrated and a desk top PC with a wide screen may display all of information items contained in the file list.

In reality, displayed information may be changed according to user selection. In detail, when a user selects the change region 1310, other information that is not currently displayed may be displayed instead of some of currently displayed information items. For example, when the user selects the change region 1310 from the user interface window 1300 illustrated in FIG. 13, information on lastly corrected time of each file may be displayed instead of a file size.

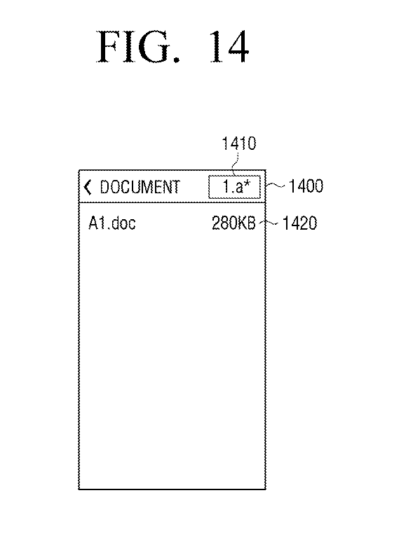

The search region 1320 may be a region for reception of a command for searching for a specific file. In response to the search region 1320 being selected, a region for reception of a search keyword may be displayed, and when a keyword is received from a corresponding region, a search result corresponding to a keyword may be displayed. This example will be described below with reference to FIG. 14.

FIG. 14 is a diagram illustrating an example of a user interface window 1400 for displaying a search list.

Referring to FIG. 14, the user interface window 1400 may include a keyword input region 1410 and a search result display region 1420.

The keyword input region 1410 may be a region for receiving a search keyword from a user. In the illustrated example, although the case in which only a document keyword is received is illustrated, in reality, file attribute, a file size range, correction time, and so on may be received.

The search result display region 1420 may be a region for displaying a search result corresponding to a keyword received from the keyword input region 1410.

FIG. 15 is a diagram illustrating an example of a setting image of a cloud management system according to an exemplary embodiment of the present disclosure.

Referring to FIG. 15, a user interface window 1500 may include an input region 1510 for receiving cloud server account information, an alignment option region 1520, an option region 1530 for a redundant file, a storage priority option region 1540, a synchronization period region 1550, a setting completion region 1560, and a setting termination region 1570.

The input region 1510 may be a region for receiving user account information of each cloud server usable by a user. In the illustrated example, although the case in which only an ID and a password of four cloud servers are received is illustrated, in reality, information of three or less and five or more cloud servers may be received. In addition, the characteristics of each cloud server (personal user/business use/backup use, etc.) of each cloud server, an account expiration period, an account management cost, etc. as well as an ID and password information may be received.

The alignment option region 1520 may be a region for receiving setting of an aligning method for displaying a file list as default. For example, any one of sequential (or reverse) alignment with respect to a capacity size, sequential (or reverse) alignment with respect to a file name, and sequential (or reverse) alignment with respect to lastly corrected time may be selected.

The option region 1530 for a redundant file may be a region for receiving setting of whether any one of redundant files is managed to be deleted when the same file is redundantly stored. When the option region is set, the management server 100 may search for whether redundant files are present and delete at least one of the redundant files.

In response to a file being received from a user terminal apparatus, the storage priority option region 1540 may be a region for receiving user setting of a cloud server in which a corresponding file is to be stored. In reality, the cloud server may be set with different priority according to a file type. For example, files of doc. may be stored according to an order of a first cloud server->a second cloud server and an MP3 file may be stored according to an order of a third cloud server->a fourth cloud server.

The synchronization period region 1550 may be a region for receiving setting a period for updating a file list. For example, when a user sets one day as a synchronization period, the management server 100 may update the file list in a unit of one day.

The setting completion region 1560 may be a region for receiving a user command for reflecting setting or input content to the user interface window 1500.

The setting termination region 1570 may be a region for receiving a close command of a currently displayed user interface window 1500 without a change of preset setting.

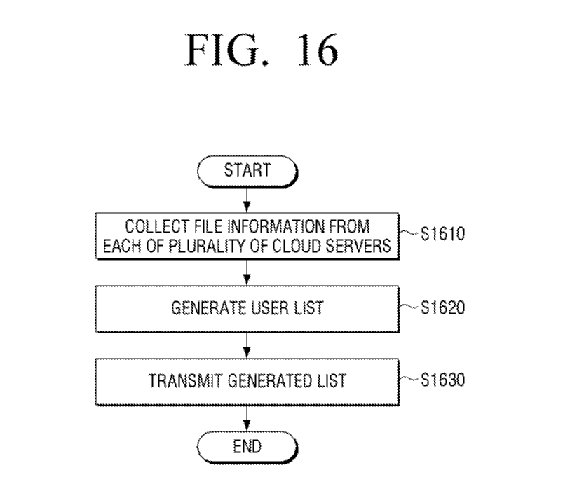

FIG. 16 is a flowchart for explanation of a file managing method of a management server according to an exemplary embodiment of the present disclosure.

Referring to FIG. 16, first, the management server 100 may pre-store user account information on each of a plurality of cloud servers.

The management server 100 may receive a request of a file list from the user terminal apparatus 200 or may request each cloud server 300 to transmit file information corresponding to a user account to each cloud server 300 and receive the file information at preset time (e.g., time when initial account information is received or a preset period) (S1610).

The management server 100 may generate a file list of corresponding users using the received file information. In detail, the management server 100 may generate a plurality of file lists based on at least one of use of a received file, a security degree, and file attribute. The management server 100 may generate a thumbnail image of a file contained in the file list.

In addition, the management server 100 may transmit the generated file list to the user terminal apparatus 200 corresponding to the user account.

As described above, in the file managing method according to the present exemplary embodiment, files stored in a plurality of cloud servers may be displayed on one UI window and, thus, the user may easily manage the files stored in the plurality of cloud servers. The file managing method of a management server illustrated in FIG. 16 may be performed on a management server including components of FIG. 3 or may also be performed on a management server including other components.

The aforementioned file managing method of a management server may be embodied as a program (or application) including an executable algorithm that is executable by a computer and the aforementioned program may be stored in a non-transitory computer readable medium and provided.

The non-transitory computer readable medium is a medium that semi-permanently stores data and from which data is readable by a device, but not a medium that stores data for a short time, such as register, a cache, a memory, and the like. In detail, the aforementioned various applications or programs may be stored in the non-transitory computer readable medium, for example, a compact disc (CD), a digital versatile disc (DVD), a hard disc, a bluray disc, a universal serial bus (USB), a memory card, a read only memory (ROM), and the like, and may be provided.

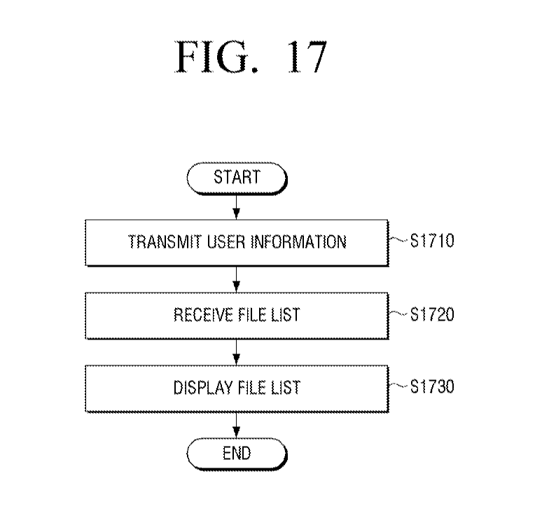

FIG. 17 is a flowchart for explanation of a file managing method of a user terminal apparatus 100 according to an exemplary embodiment of the present disclosure.

Referring to FIG. 17, the user terminal apparatus 100 may receive user information from a user and transmit the received user information to the management server 100 (S1710). Here, the user information may include user account information for access to a file management system.

In response to transmission of the user information, a file list corresponding to the user account may be received from the management server 100 (S1720) and the received file list may be displayed (S1730). In this case, when the user changes a display method or inputs a search keyword, the user terminal apparatus 100 may change a display method using the received file list and display the file list or may search for a file corresponding to the search keyword and display the file. In reality, a file list, the received display method of which is changed, may be requested to the management server 100 or a search keyword may be requested to the management server 100 and the changed file list may be received from the management server 100 or the search list may be received and displayed.

As described above, the file managing method of a user terminal apparatus according to the present exemplary embodiment may display files stored in a plurality of cloud servers in one UI window and, thus, the user may check and manage the files stored in the plurality of cloud servers. The file managing method of the user terminal apparatus illustrated in FIG. 17 may be performed by a user terminal apparatus including components of FIG. 12 and may also be performed by a user terminal apparatus with other components.

The management server and method thereof according to an exemplary embodiment, generates a file list to be provided via a user interface (UI) which consolidates information of files stored across the plurality of cloud servers. Further, user account information correspondingly associated with a plurality of cloud servers may be registered with a management account useable to access the files stored across the plurality of cloud servers, and/or the UI may be configured to operate a corresponding function of the plurality of cloud servers.

The aforementioned file managing method of a user terminal apparatus may be embodied as a program (or application) including an executable algorithm that is executable by a computer and the aforementioned program may be stored in a non-transitory computer readable medium and provided.

The foregoing exemplary embodiments and advantages are merely exemplary and are not to be construed as limiting the present disclosure. The present teaching can be readily applied to other types of apparatuses. Also, the description of the exemplary embodiments of the present disclosure is intended to be illustrative, and not to limit the scope of the claims, and many alternatives, modifications, and variations will be apparent to those skilled in the art.

What is claimed is:

1. A management server connectable to a plurality of cloud servers, comprising:
a storage configured to store user account information correspondingly associated with the plurality of cloud servers;
a communicator configured to receive file information of a user file stored in any one or more of the plurality of cloud servers using the stored user account information correspondingly associated with the plurality of cloud servers; and
a processor configured to generate a file list including the user file based on the received file information.

2. The management server as claimed in claim 1, wherein the processor controls the communicator to provide the generated file list including the user file to a user terminal apparatus.

3. The management server as claimed in claim 2, wherein, in response to search information being received from the user terminal apparatus, the processor generates a search list corresponding to the received search information using the file list and controls the communicator to transmit the generated search list to the user terminal apparatus.

4. The management server as claimed in claim 2, wherein, in response to a request to store information being received from the user terminal apparatus, the processor stores the received information in one or more of the plurality of cloud servers.

5. The management server as claimed in claim 4, wherein the processor determines a cloud server in which the received information is to be stored among the plurality of cloud servers in consideration of one or more of a storage capacity, a storing period, a storing cost, and a storing speed of the cloud server relative to the plurality of cloud servers, and stores the received information in the determined cloud server.

6. The management server as claimed in claim 4, wherein the processor determines a cloud server in which the received information is to be stored among the plurality of cloud servers based on one or more of use of the received information, a security degree, and a file attribute corresponding to the received information and stores the received information in the determined cloud server.

7. The management server as claimed in claim 2, wherein, in response to a print command being received from the user terminal apparatus, the processor receives information corresponding to the received print command in association with a cloud server among the plurality of cloud servers, in which the file is stored, and controls the communicator to transmit the received file to an image forming apparatus.

8. The management server as claimed in claim 7, wherein the processor generates print data corresponding to the received information and controls the communicator to transmit the generated print data to the image forming apparatus.

9. The management server as claimed in claim 1, wherein the communicator receives file information of a plurality of files including the user file, and
the processor generates the file list to include one or more of the plurality of files and the user file by setting an order for the file list based on a preset condition.

10. The management server as claimed in claim 1, wherein the processor generates a thumbnail image corresponding to file content included in the file list including the user file, and stores the thumbnail image in the storage.

11. The management server as claimed in claim 1, wherein a plurality of redundant files are stored in different cloud servers among the plurality of cloud servers, and the processor deletes one or more of the plurality of redundant files.

12. The management server as claimed in claim 1, wherein the processor performs backup of the user file to a different cloud server from a cloud server among the plurality of cloud servers in which the user file is stored.

13. The management server as claimed in claim 1, wherein the processor moves all files stored in one cloud server among the plurality of cloud servers to one or more other cloud server among the plurality of cloud servers, and updates the file list.

14. The management server as claimed in claim 1, wherein the processor generates a plurality of file lists including the file list based on one or more of use, a security degree, and a file attribute of the user file.

15. The management server as claimed in claim 1, wherein the file list comprises one or more of a file name, a file attribute, a file size, information on a cloud server among the plurality of cloud servers in which the user file is stored, and position information at which the user file is stored in the cloud server.

16. A file managing method of a cloud server, the method comprising:
receiving file information of a user file stored in any one or more of a plurality of cloud servers using pre-stored user account information correspondingly associated with the plurality of cloud server;
generating a file list including the user file based on the received file information; and
transmitting the generated file list to a user terminal apparatus corresponding to the pre-stored user account information.

17. The method as claimed in claim 16, further comprising:
generating a search list corresponding to the received search information using the file list in response to search information being received from the user terminal apparatus; and
transmitting the generated search list to the user terminal apparatus.

18. The method as claimed in claim 16, further comprising:
receiving information from the user terminal apparatus; and
storing the received information in at least one of the plurality of cloud servers.

19. The method as claimed in claim 16, further comprising backing up the user file to a different cloud server form a cloud server in which the file is stored with respect to at least one file included in the file list.

20. A non-transitory computer readable recording medium having recorded thereon a program for executing a file managing method, the method comprising:
receiving file information of a user file stored in any one or more of a plurality of cloud servers using pre-stored user account information correspondingly associated with the plurality of cloud server;
generating a file list including the user file based on the received file information; and
transmitting the generated file list to a user terminal apparatus corresponding to the pre-stored user account information.
